(19) United States
(12) Patent Application Publication
(10) Pub. No.: US 2017/0224170 A1
(43) Pub. Date: Aug. 10, 2017

(54) ANTI-CAVITATION FOOD BLENDER OR PROCESSOR

(71) Applicant: Spectrum Brands, Inc., Middleton, WI (US)

(72) Inventors: Kroy Everett Nernberger, Madison, WI (US); Jacob Daniel Smith, Monona, WI (US)

(21) Appl. No.: 15/427,518

(22) Filed: Feb. 8, 2017

Related U.S. Application Data
(60) Provisional application No. 62/293,075, filed on Feb. 9, 2016.

(51) Int. Cl. A47J 43/08; A47J 43/07; A47J 43/046

(52) U.S. Cl. CPC A47J 43/085; A47J 43/046; A47J 43/0722

(57) ABSTRACT

An improved blender or food processor is provided that moves a blade translationally in the vertical plane while another blade or blade assembly rotates in the horizontal plane to stop the blender from cavitating the contents while blending viscous fluids (an air pocket from forming around the cutting blades or forming a vortex or a disruptive vacuum). Both actions of rotating the lower blades and translationally moving the upper blade are done simultaneously using one motor. In a related embodiment, rotational and translational movements are provided with decoupled gear assemblies.

### CLAIM OF PRIORITY

This application claims priority to and the benefit of a U.S. Provisional Application with Ser. No. 62/293,075, filed on Feb. 9, 2016, which is incorporated herein by reference in its entirety.

### FIELD AND BACKGROUND OF THE INVENTION

The invention relates generally to a food blender or food processor having a jar or jug and rotating blade or blades at the bottom of the jar or jug.

Most food processors or blenders may process fruit or vegetables or even ice that is placed in the jar or jug and the blades rotated rapidly to convert the food into a slurry or crush the ice finely. Known food blenders have a number of shortcomings including: 1) when food is of a thick consistency and in a large volume it is unable to circulate within the blender jug; 2) food can sometimes make an arch around the blades which results in the blades not having contact with the food and therefore it is not processed and; 3) the center of the blades do not cut the food being processed and as a vortex is formed (visible as a swirl) by rotation of the blades takes the food to the center of the blades the result is that large pieces food and ice are not processed. In some cases a vacuum is formed (or cavitation occurs) in which there is a pocket of air that is getting formed and not all food is being processed or blended.

### SUMMARY

There is provided a new blender or food processor concept that moves a blade translationally in the vertical plane while another blade or blade assembly rotates in the horizontal plane and stops the blender from cavitating the contents while blending viscous fluids (an air pocket from forming around the cutting blades (cavitation) or the formation of a vortex or a disruptive vacuum). Both actions of rotating the lower blades and translationally moving the upper blade are done simultaneously using one motor.

In one example embodiment, a blender blade moves translationally in a vertical plane while a second blade or blade assembly rotates in a horizontal plane, thereby preventing cavitation which leads to inefficient cutting or mixing of ingredients. Both movements are performed using a single motor using a unique gear train and this improvement eliminates that need for stirring sticks or having to open the blender to stir the contents due to the inefficient cutting of prior blenders and food processors. In this example embodiment, the gear train used a spur gear assembly with two helical gears at a 1:1 ratio to drive the rotation and a worm/worm wheel combination to drive the translational movement. In another embodiment, a hypoid gear arrangement is used in place of the spur gear assembly to drive the rotational and translational movement. In a related embodiment, the desired functionality can also be achieved by translationally moving the rotating blade, up and down continuously in an oscillating fashion. Such an action, either by the oscillating rod or oscillating blade assembly, breaks up the vacuum or air pockets created and force the food to be directed back to the blades or the ingredients to be properly mixed.

In another embodiment, there is provided a food processor having a jar body assembly and a base with a motor drive located within the base, the jar body assembly including a first shaft or rod having a blade assembly disposed on a proximal end, the first shaft having a second shaft disposed therein and adapted to move within the first shaft and protruding from a distal end of the first shaft, the first shaft having a top blade member disposed on an upper distal end spaced above the blade assembly. The food processor also includes a spur gear assembly coupled to the first shaft for axially rotating the first shaft at the proximal end, the spur gear assembly including a first spur gear coupled to the first shaft and a second spur gear coupled laterally to the first spur gear. In addition, the food processor includes a worm gear assembly coupled to the spur gear assembly and to the first shaft, a drive shaft of a worm gear of the worm gear assembly coupled to the second spur gear and a worm wheel gear of the worm gear assembly coupled to a base member of the proximal end of the second shaft to translationally move the second shaft vertically in an oscillating motion, the drive shaft of the worm gear configured to be coupled to and driven by the motor drive in the base. In a related embodiment, the spur gear assembly is comprised of two helical gears having a 1:1 ratio. In another related embodiment, a hypoid gear assembly is coupled to the first shaft for axially rotating the first shaft. In related embodiments, the blade assembly and the top blade member of the food processor are selected from the group consisting of a single blade, a dual blade assembly and a triple blade assembly.

In yet another embodiment, there is provided a food processor having a jar body assembly and a base with a motor drive located within the base, the jar body assembly including a shaft having a blade assembly disposed on a distal end of the shaft and a base member disposed on a proximal end of the shaft. The food processor further includes a spur gear assembly coupled to the shaft for axially rotating the shaft, the spur gear assembly including a first gear coupled to the shaft and a second gear coupled laterally to the first gear. In addition, the food processor includes a worm gear assembly coupled to the spur gear assembly and to the shaft, a drive shaft of a worm gear of the worm gear assembly coupled to the second gear and a worm wheel gear of the worm gear assembly coupled to the base member of the proximal end of the shaft to translationally move the shaft vertically in an oscillating motion, the drive shaft configured to be coupled to and driven by the motor drive in the base. In a related embodiment, the food processor has a spur gear assembly is comprised of two helical gears having a 1:1 ratio. In related embodiments of food processor, the blade assembly and the top blade member are selected from the group consisting of a single blade, a dual blade assembly and a triple blade assembly.

In yet another example embodiment, there is provided a food processor jar body assembly configured for a food processor system, the food processor system having the jar body assembly and a base with a motor drive located within the base, the jar body assembly including a shaft body and a blade assembly disposed within an upper portion of the jar body assembly, the jar body assembly having a lower portion and a floor separating the upper and lower portions of the jar body assembly, the shaft body having an inner shaft disposed therein with the blade assembly disposed on a distal end of the inner shaft, the inner shaft having a base member disposed on a proximal end of the inner shaft, the base member configured to be engaged with the motor drive and axially rotate the inner shaft independent of the shaft body. The jar body assembly further includes a worm gear assembly disposed within the lower portion of the jar body assembly and located below the floor, the worm gear assembly operatively coupled to the shaft body and configured to translationally move the shaft body vertically in an oscillating motion, the worm gear assembly including a threaded bracket member disposed about the shaft body and at least one worm gear shaft engaged with the threaded bracket member, the at least one worm gear shaft having a worm gear shaft base member disposed on a proximal end of the worm gear shaft, the worm gear shaft base member configured to be engaged with a second motor drive to translationally move the threaded bracket member and the shaft body vertically in an oscillating motion. In one example embodiment, the worm gear assembly includes a second and a third worm gear shaft engaged with the threaded bracket member and the jar body assembly further includes an idler gear assembly disposed within the lower portion of the jar body assembly and configured to engage the first, second and third worm gear shafts in imparting a rotational movement to the worm gear shafts when the first worm gear shaft is engaged with the second motor drive. In this example embodiment, the idler gear assembly includes at least a first idler gear disposed about the first worm gear shaft, a second idler gear disposed about to the second worm gear shaft and a third idler gear disposed about the third worm gear shaft. In a related embodiment, the idler gear assembly includes a fourth idler gear and all of the idler gears are in operative contact with each other in imparting the rotational movement to the worm gear assembly.

In an embodiment related to the aforementioned embodiment, the food processor jar body assembly further comprises a worm gear assembly support plate configured to support the threaded bracket member and to support the first, second and third worm gear shafts radially about the threaded bracket member. In related embodiments, the food jar body assembly includes at least two electrical limit switches electrically coupled to the second motor and configured to change the direction of translational travel of the shaft body. In related embodiments, the inner shaft base member and the worm gear assembly base member are configured in a ring with external fins disposed radially about the ring structure to facilitate engaging the motor drives. In yet another related embodiment, the food processor jar body assembly further includes a stabilizer bracket disposed about the shaft body and below the blade assembly to engage the floor of the jar body assembly and seal the upper portion of the jar body assembly from the lower portion. In related embodiments, the blade assembly of the food processor jar body is selected from the group consisting of a single blade, a dual blade assembly and a triple blade assembly.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

FIG. 1 illustrates a side translucent view of a food processor jar body assembly with an anti-cavitation blending assembly with an oscillating top blade member within a food processing jar according to the teachings herein;

FIGS. 2A-2D illustrate perspective views of an anti-cavitation blending assembly with an oscillating rod with a top blade member along with the various gear assemblies that impart the rotational and translational movement of the top blade member according to the teachings herein;

FIG. 3 illustrates a side translucent view of a food processor jar body assembly with an anti-cavitation blending assembly with an oscillating blade assembly within a food processing jar according to the teachings herein;

FIGS. 4A-4C illustrate perspective views of an anti-cavitation blending assembly with an oscillating blade assembly along with the various gear assemblies that impart the rotational and translational movement of the top blade member according to the teachings herein;

FIG. 5 illustrates a side translucent view of a food processor jar body assembly with an anti-cavitation blending assembly having combined rotational and oscillating blade movement disposed within upper and lower portions of a food processing jar according to the teachings herein;

FIGS. 6A-6B illustrate perspective views of an anti-cavitation blending assembly with the gear assemblies that impart the rotational and translational movement of the shaft body and blade member according to the teachings herein; and

FIGS. 7A-7B illustrate side views of an anti-cavitation blending assembly with the gear assemblies that impart the rotational and translational movement of the shaft body and blade member according to the teachings herein.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of the invention are directed to a new blender or food processor that adds a vertical movement to a rotational blade form factor thereby preventing the user from having to open the pitcher and stir the contents due to cavitation. The blending assemblies described herein automatically pull contents down and into the primary cutting blades and improving the cutting and mixing ability of the device.

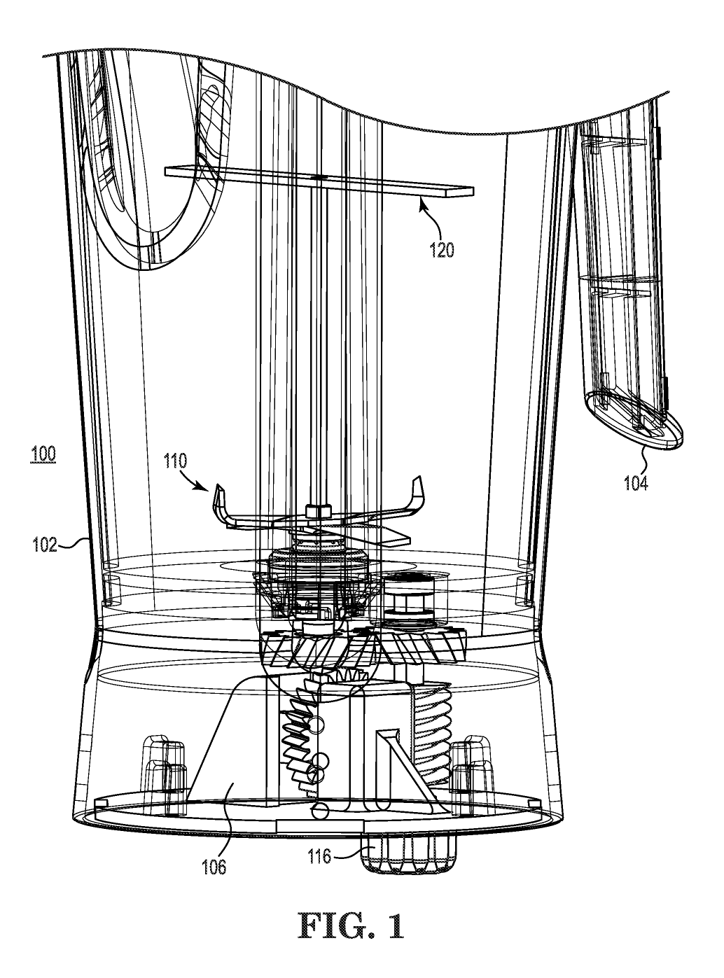

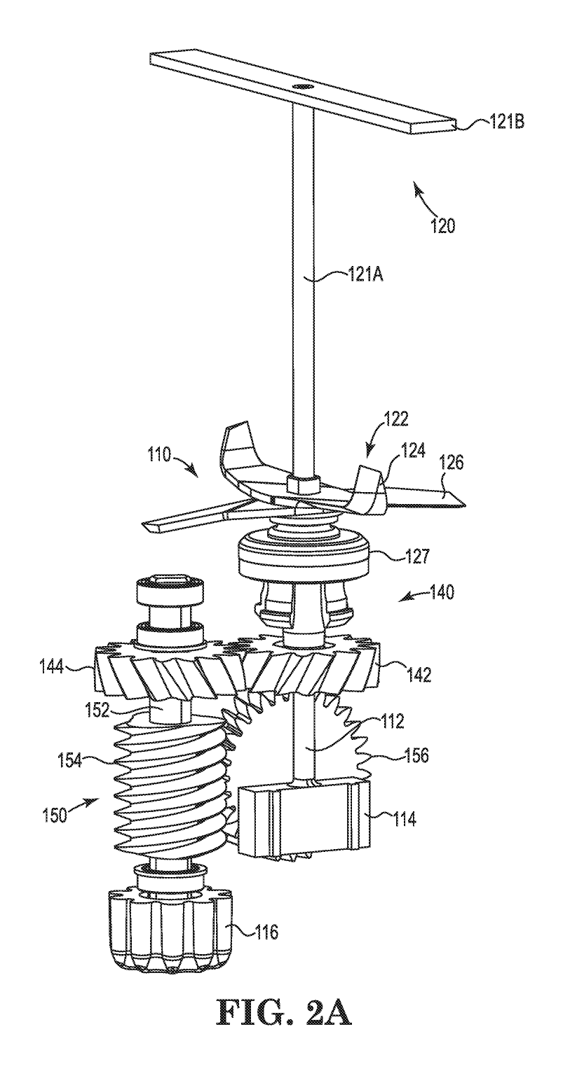

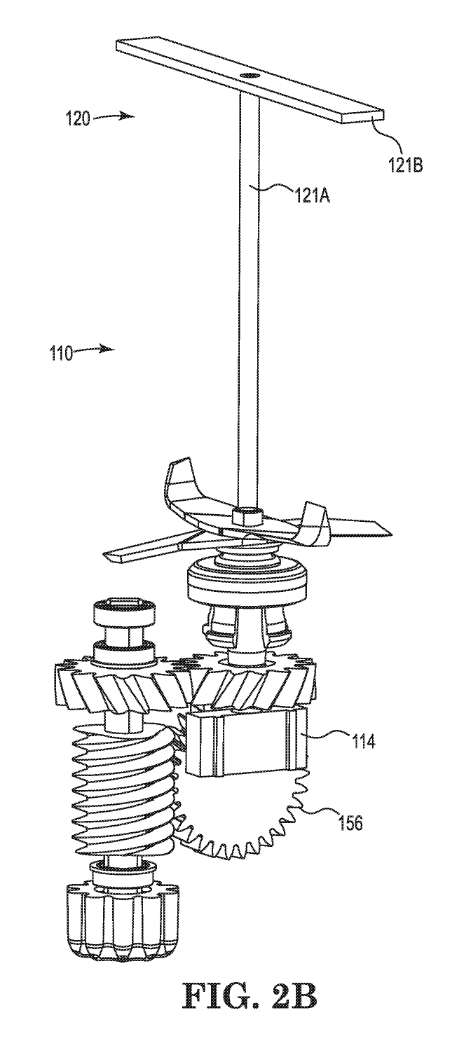

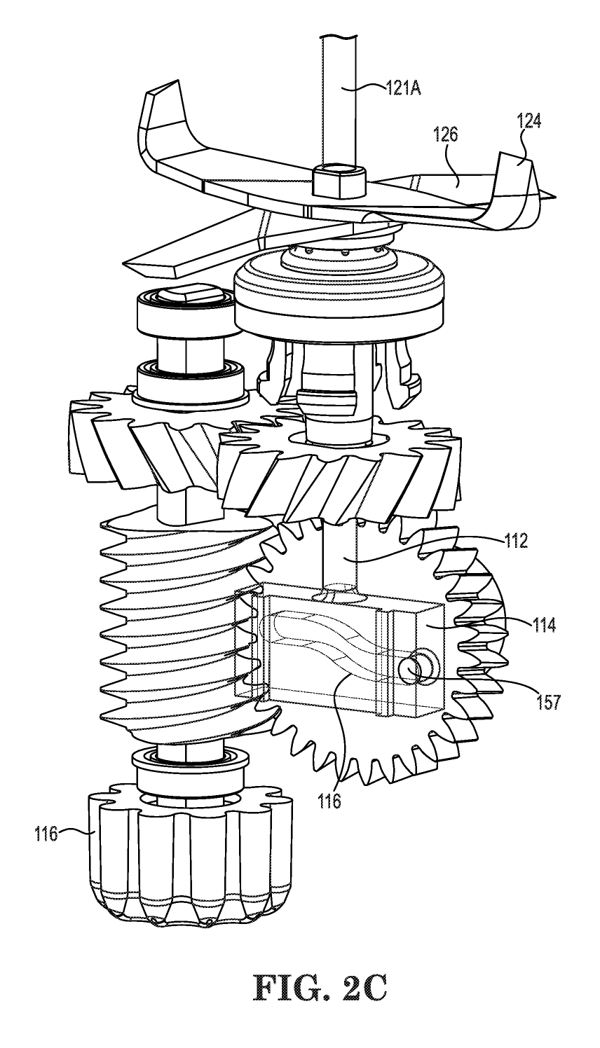

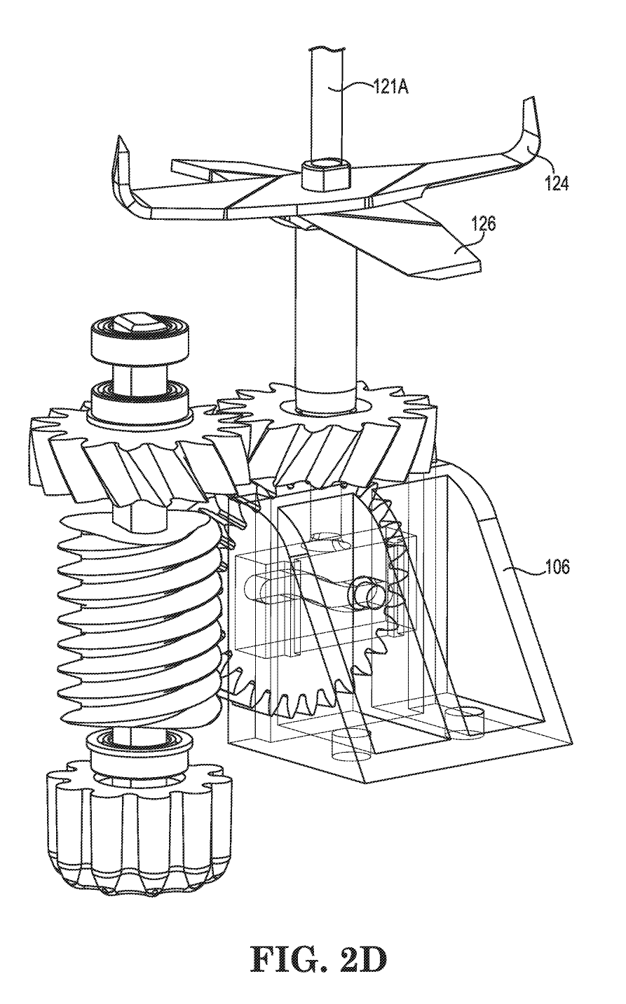

Referring now to the figures, FIG. 1 illustrates a side translucent view of a food processor assembly 100 with an anti-cavitation blending assembly 110 (supported by a gear support member 106; also shown in FIG. 2D) with an oscillating rod top blade member 120 within a food processing jar body 102 having a handle 104 according to the teachings herein. Although not shown, various embodiments described herein are configured to operate with a standard food processor base with a motor drive located therein and mechanism for engaging the gear assemblies described hereafter.

Referring to FIGS. 2A-2D there are illustrated views of an anti-cavitation blending assembly 110 with a rod and top blade arrangement 120 and a rotating bottom blade assembly 122, with an oscillating rod or shaft 121A including a top blade member 121B. Blending assembly 110 also includes various gear assemblies 130, 140 and 150 that impart the rotational movement of the bottom blade assembly 122 and translational movement of rod 121A and top blade member 121B. In this example embodiment, blending assembly 110 includes a shaft 112 having disposed on a distal end bottom blade assembly 122, where rod or shaft 121A, oscillates and travels within shaft 112. Shaft 112 includes a base member 114 disposed on the proximal end where base member 114 is coupled to a worm wheel gear 156 to facilitate translational movement of shaft 112. In particular, as shown in FIGS. 2C-2D, there is a pin 157 on a worm wheel gear 156 that fits inside a slot 116 in the base member 114. As the worm wheel spins or rotates, pin 157 slides in slot 116 and moves base member 114 up and down. Gear assembly 130 includes a spur gear assembly 140 coupled to shaft 112 (in FIG. 2A), while shaft 121A travels within another shaft 112 such that shaft 121A only travels up and down while shaft 112 is attached to gear 140 and rotates the blade assembly 122 and axially rotates the shaft. Spur gear assembly 140 includes a first gear 142 coupled to shaft 112 and a second gear 144 coupled laterally to first gear 142. Gear assembly 130 further includes a worm gear assembly 150 coupled to spur gear assembly 140 and to shaft 112, worm wheel gear assembly 150 including a drive shaft 152 of a worm gear 154 coupled to second gear 144; a worm wheel gear 156 of the worm wheel gear assembly is coupled to base member 114 of the proximal end of shaft 112 to translationally move the shaft 121A vertically in an oscillating motion. In this example embodiment, drive shaft 152 is configured to couple (at a motor attachment ring 116) with and be driven by the motor drive in the base of the food processor.

In this example embodiment, spur gear assembly 140 is comprised of two helical gears 142, 144 having a 1:1 gear ratio. In this example embodiment, blade assembly 122 includes a blade 124 with ends that are protruding upwards and a flat blade 126. During operation, the bottom blade assembly 122 and shaft 121A rotate within bushing assembly 127, which acts as a seal to keep blended materials in a pitcher 102 and away from the gear assembly. In any of the blending assemblies described herein, the blade assembly is selected from the group consisting of, but is not limited to, a single blade, a dual blade assembly and a triple blade assembly. In this embodiment, the lower blade assembly rotates and the upper blade member only actuates. In other embodiments, the top upper blade member could actuate and rotate. In other related embodiments, other means to vertically actuate a blade or blade assembly can be used.

In a related embodiment, a food processor having a jar body and a base with a motor drive located therein includes a shaft having disposed on a distal end a top blade member and a blade assembly disposed on the shaft below and spaced from the top blade member, the shaft having a base member disposed on the proximal end with a gear assembly. In one example embodiment, the food processor includes a hypoid gear assembly coupled to the shaft for axially rotating the shaft, the hypoid gear assembly including a ring gear coupled to the shaft and a pinion gear coupled laterally to the ring gear. In this example embodiment, the processor also includes a worm gear assembly coupled to the hypoid gear assembly and to the shaft, with a worm gear member being disposed on a pinion gear shaft below the pinion gear head and coupled to a worm wheel gear. The worm wheel gear is further coupled to the base member of the proximal end of the shaft to translationally move the shaft vertically in an oscillating motion, the drive shaft configured to be coupled to and be driven by the motor drive in the base.

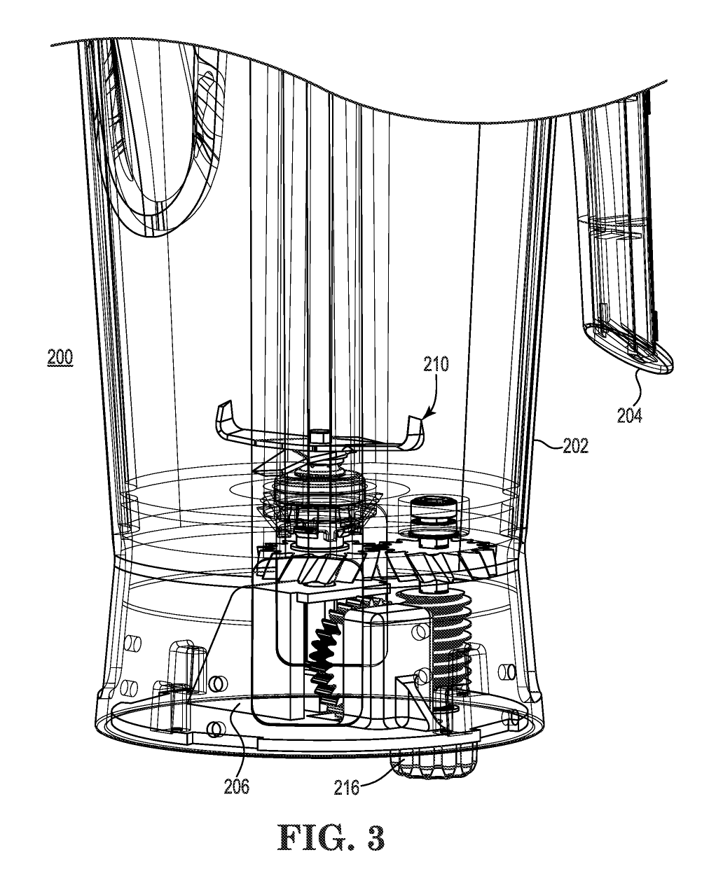

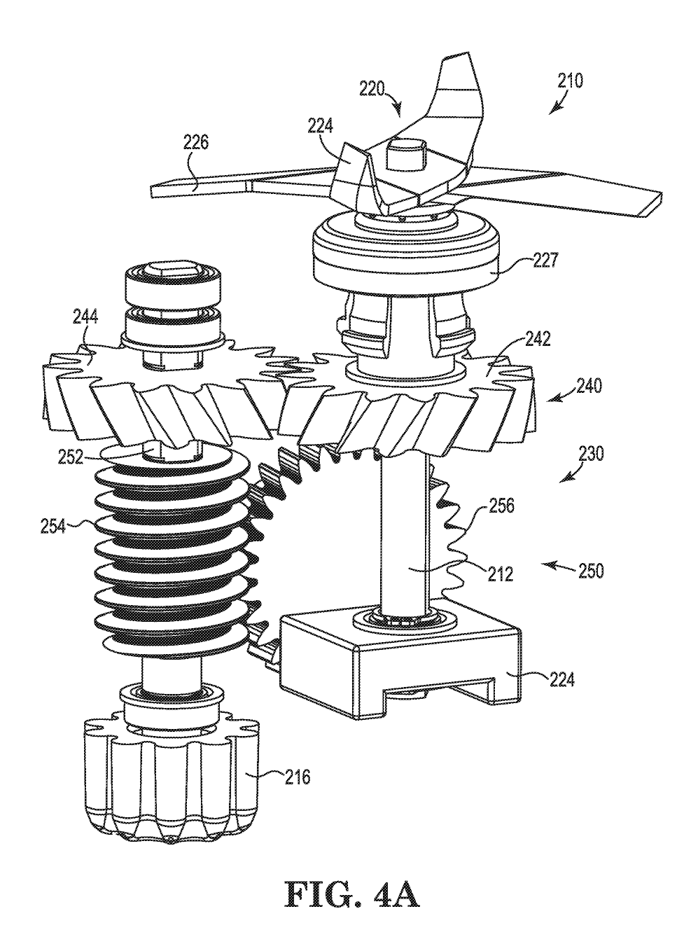

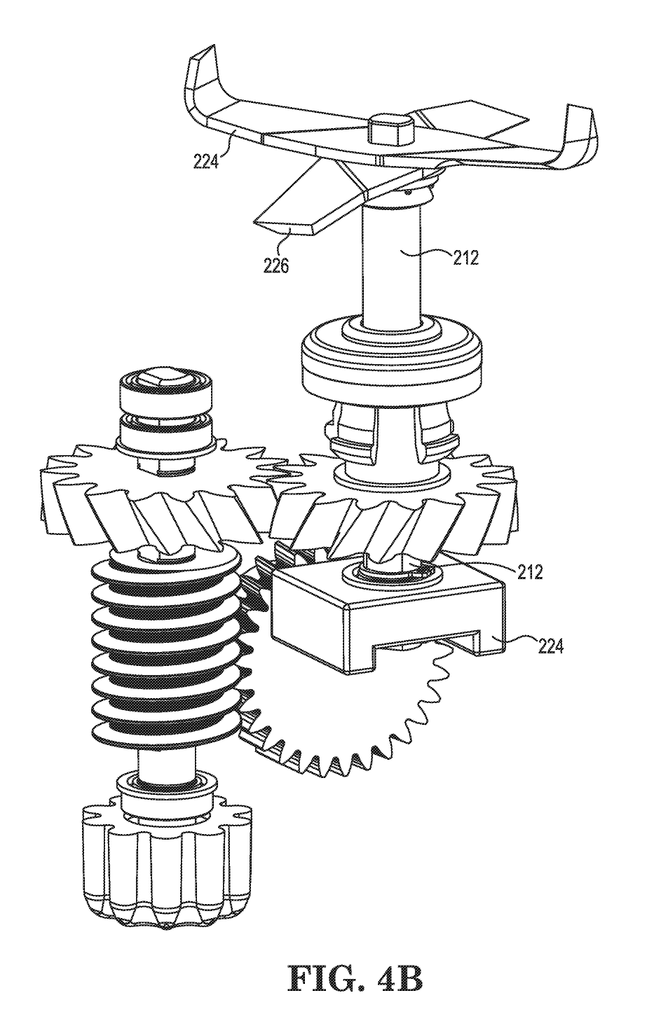

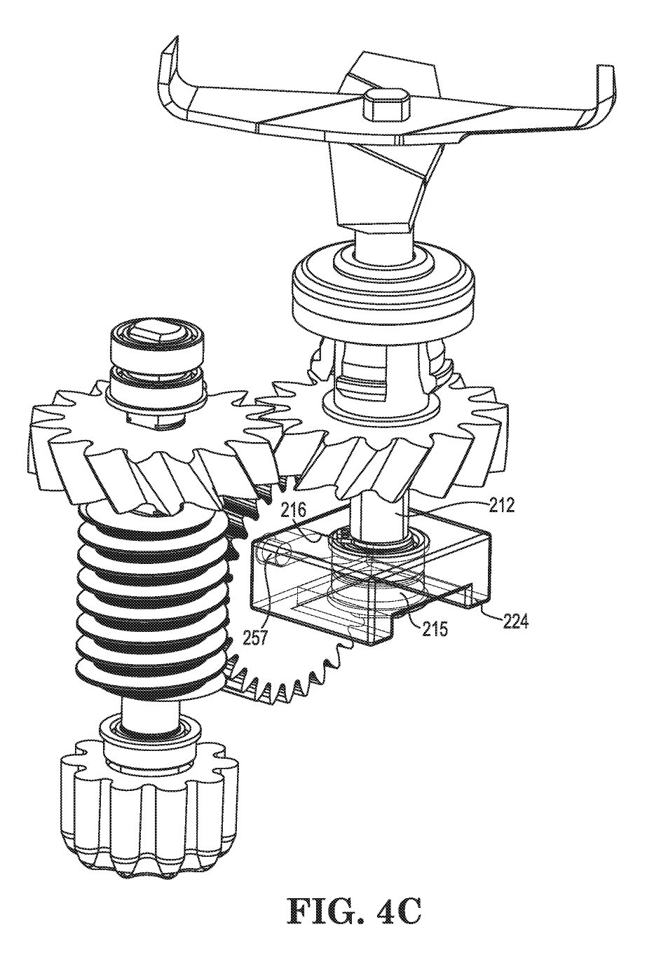

Referring now to FIGS. 3 and 4A-4C, FIG. 3 illustrates a side translucent view of a food processor assembly 200 with an anti-cavitation blending assembly 210 (supported by a gear support member 206). Blending assembly 210 includes an oscillating blade arrangement 220 located within a food processing jar 202 having a handle 204. FIGS. 4A-4C illustrate views of anti-cavitation blending assembly 210 with various gear assemblies 230, 240 and 250 that impart the rotational and translational movement of blade assembly 222. Blending assembly 210 further includes, in this example embodiment, a shaft 212 having disposed on an upper distal end a blade assembly 220 and a base member 224 disposed on the proximal end that is coupled to a worm wheel gear 256. Worm wheel 256 has a pin 257 on it that fits in a slot 216 on base member 224. In this embodiment, shaft 212 does rotate and actuate with the actuation being done by worm wheel 256 and base member 224, and the rotation being done by spur gear assembly 240. The distal end of shaft 212 includes a ball bearing holder 215 located within base member 224, which is considered the linear actuator in most embodiments disclosed herein. Hence, the ball bearing within the holder 215 allows shaft 212 to rotate within base member 224 and member 224 moves the shaft 212 up and down.

In this example embodiment, gear assembly 230 includes a spur gear assembly 240 coupled to shaft 212 for axially rotating shaft 212, the spur gear assembly using a first gear 242 coupled to shaft 212 and a second gear 244 coupled laterally to the first gear 242 to implement the rotational movement of the blade assembly. A worm gear assembly 250, in this example embodiment, is coupled to spur gear assembly 240 and to shaft 212, with a drive shaft 252 of a worm gear 254 being coupled to second gear 244. A worm wheel gear 254 is coupled to motor attachment ring member or base member 216 of the proximal end of the shaft to translationally move shaft 212 vertically in an oscillating motion, drive shaft 252 being configured motor attachment ring 216 to be coupled to and driven by the motor drive in the food processor base. In this example embodiment, spur gear assembly 240 is comprised of two helical gears having a 1:1 ratio.

In this example embodiment, blade assembly 222 includes a blade 224 with ends that are protruding upwards and a flat blade 226 coupled to shaft 212. During operation, the blade assembly 222 rotates and oscillates and the shaft 212 travels through the bushing assembly 227, which creates a seal to keep the blended contents in pitcher 202. In any of the blending assemblies described herein, the blade assembly is selected from the group consisting of, but is not limited to, a single blade, a dual blade assembly and a triple blade assembly. In other related embodiments, other means to vertically actuate a blade or blade assembly can be used.

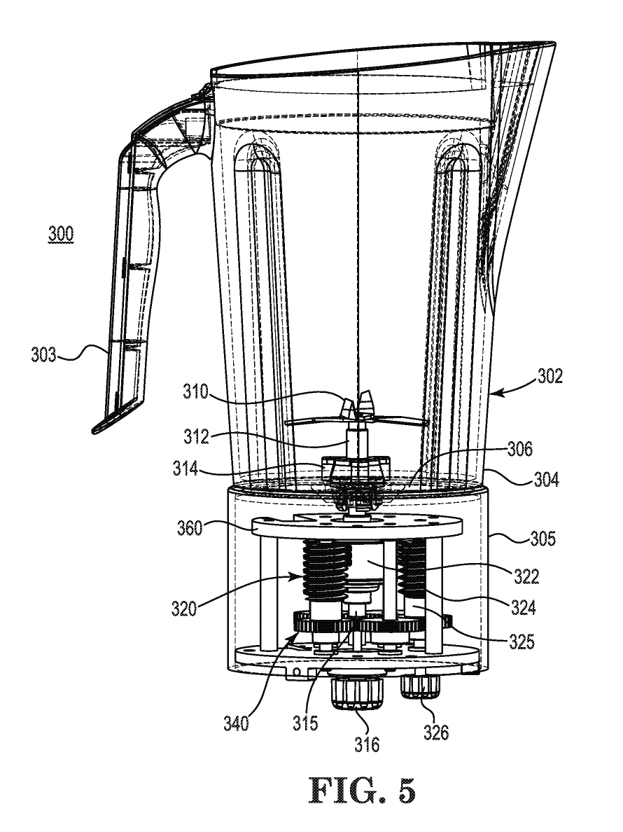

Referring now to FIGS. 5-7B, there is provided another embodiment of a food processor component 300 of a food processing system. In particular, FIG. 5 illustrates a side translucent view of a food processor jar body assembly 302 with handle 303 that includes within the jar cavity an anti-cavitation blending assembly 310/320 having combined rotational and oscillating blade movement disposed within an upper portion 304 of the jar body and a lower portion 305 of the food processing jar body. An advantage of this example embodiment is that jar body assembly 200 facilitates up and down actuation of the blade assembly as it is de-coupled and independent from the motor and blade rotation action. This design uses a large main motor to drive the rotational movement and would require a second, smaller motor for the oscillating movement, which would add a lot more control and reliability as a single set of gears are not subjected to the torque that is provided by the large motor. The center coupling or motor attachment ring 316 on the bottom drives rotation of blade 310 while the coupling off to the side motor ring 326 is what controls the actuation through 3 worm gears forming worm gear assembly 320. A center bearing assembly or stabilizing bracket 322 is secured to blade shaft body 312 and moves up and down (as the worm gears turn) and spins or rotates as the center drive coupling spins. There are thrust bearings on the top and bottom of the bearing assembly 322 to accommodate the up and down load during actuation.

In this example embodiment, food processor jar body assembly 300 is a component of a food processor system that along with the jar body 302 has a base with a motor drive located within the base. Jar body assembly 300 includes a shaft body 312 and a blade assembly 310 disposed within an upper portion 304 of jar body 302, the jar body assembly having a lower portion 305 and a floor 306 separating upper 304 and lower 305 portions of jar body assembly 300. Shaft body 312 has an inner shaft 315 disposed therein with blade assembly 310 disposed on a distal end of inner shaft 315. The inner shaft has a base or ring or coupling member 316 disposed on a proximal end of inner shaft 315, with base or coupling member 316 configured to be engaged with the motor drive (not shown) of the food processor to axially rotate inner shaft 315 independent of shaft body 312. Jar body assembly 300 further includes a worm gear assembly 320 disposed within the lower portion of the jar body assembly and is located below floor 306. Worm gear assembly 320 is operatively coupled to shaft body 312 and is configured to translationally move shaft body 312 vertically in an oscillating motion when it is engage with a motor drive. In this example embodiment, worm gear assembly 320 includes a threaded bracket member 322 that is disposed about shaft body 312 and includes at least one worm gear shaft 325 and worm gear 324 that is engaged with the threaded bracket member. Worm gear shaft 325 has a worm gear shaft base member or coupling 326 disposed on a proximal end of worm gear shaft 325, the worm gear shaft base member or coupling configured to be engaged with a second motor drive (not shown) to translationally move threaded bracket member 322 and shaft body 312 vertically in an oscillating motion.

In this example embodiment, food processor jar body assembly 300 further includes a worm gear assembly support plate 360 configured to support threaded bracket member 322 and to support worm gear assembly 320 (first, second and third worm gear shafts radially about the threaded bracket member, described later) and an idler gear assembly 340. In related embodiments, food jar body assembly 300 includes at least two electrical limit switches (not shown) that are electrically coupled to the second motor (not shown) in the base of the food processor system which are used to change the direction of translational travel of shaft body 312. In related embodiments, the inner shaft base member 316 and the worm gear assembly base member 326 are configured in a ring with external fins disposed radially about the ring structure to facilitate engaging the motor drives in the base of the food processor system. In this example embodiment, the food processor jar body assembly further includes a stabilizer bracket 314 disposed about shaft body 312 and below blade assembly 310 to engage floor 306 of jar body 302 and to seal the upper portion of the jar body assembly from the lower portion. In related embodiments, blade assembly 310 of the food processor jar body assembly is selected from the group consisting of a single blade, a dual blade assembly and a triple blade assembly.

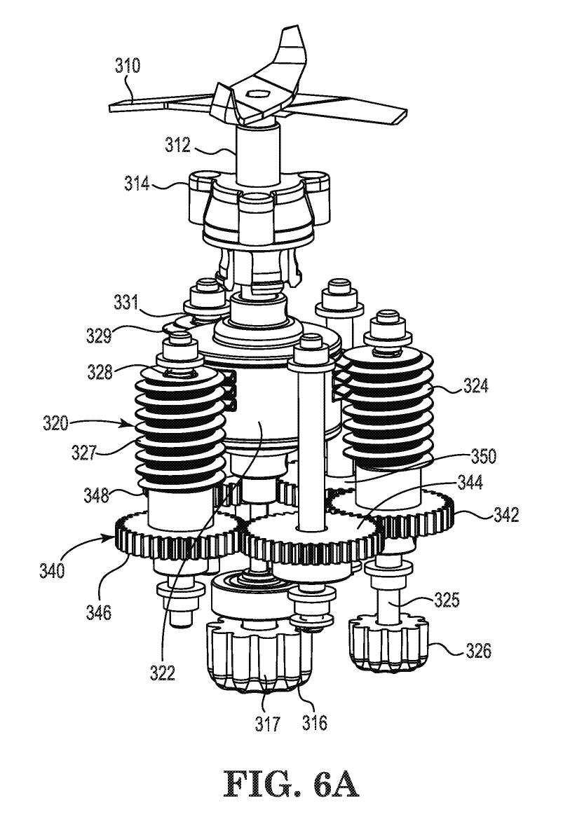

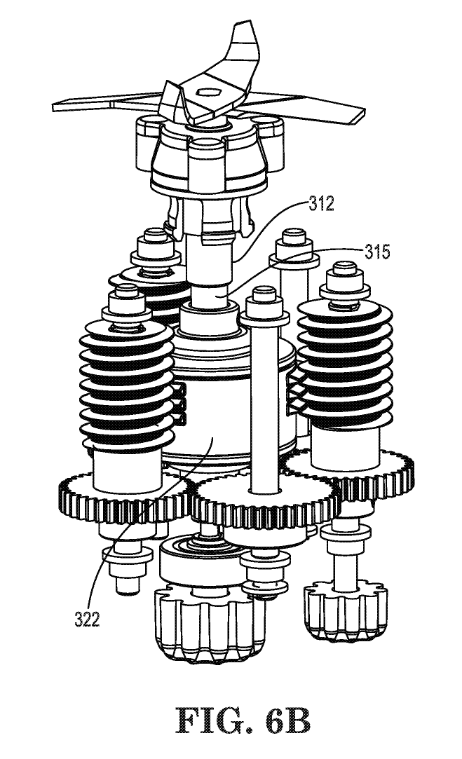

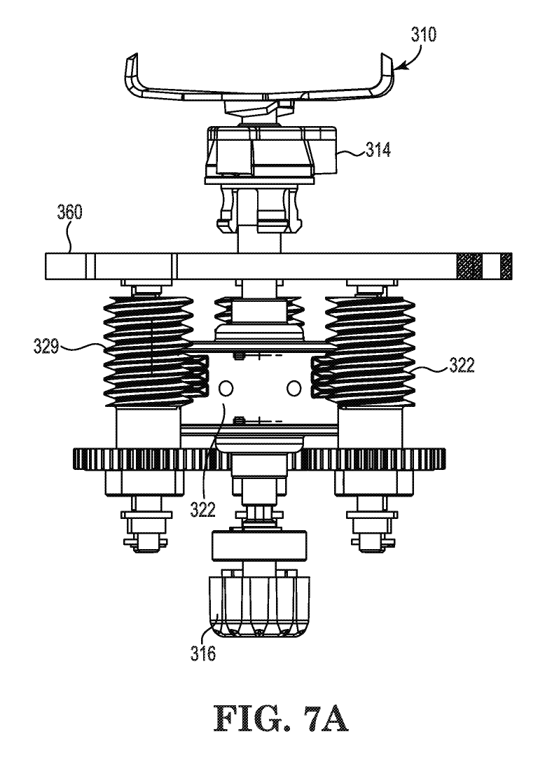

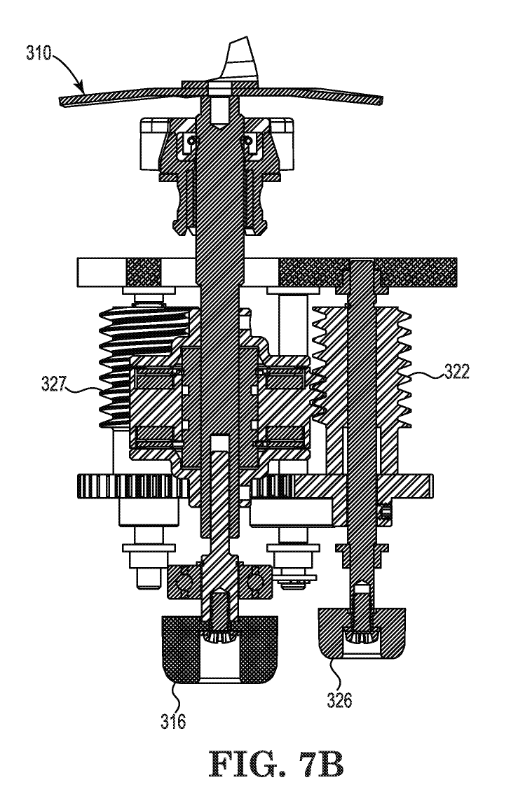

In one example embodiment, and referring more closely to FIGS. 6A-7B, worm gear assembly 320 includes a second 327 and a third 329 worm gear engaged with threaded bracket member 322. Idler gear assembly 340 disposed within the lower portion of the jar body assembly engages first 324, second 327 and third 329 worm gears in imparting a rotational movement to the worm gear shafts when the first worm gear shaft 325 is engaged with the second motor drive (not shown). In this example embodiment, idler gear assembly 340 includes at least a first idler gear 342 disposed about the first worm gear shaft 325, a second idler gear 346 disposed about to the second worm gear shaft 328 and a third idler gear 348 disposed about the third worm gear shaft 331. In this embodiment, idler gear assembly 340 includes a fourth idler gear 344 and a fifth idler gear 350 with all of the idler gears being in operative contact with each other in imparting the rotational movement to worm gear assembly 340 and to threaded bracket member 322.

Referring again to FIGS. 6A-6B there is illustrated perspective views of raised and lowered configurations of shaft body 312 (showing inner shaft 315 as well) and how threaded bracket member 322 engages the various worm gears. With respect to FIGS. 7A-7B, there are illustrated side views of lowered configurations of shaft body 312 with respect to the worm gears and to support plate 360. Note that FIG. 7B illustrates the decoupled structure of the rotational aspect driven by member 316 and the translation aspect driven by member 326. This approach also provides for rotational movement of the blade assembly should the translational movement become inoperative.

The following patents and publications are incorporated by reference in their entireties: U.S. Pat. Nos. 5,645,346; 6,254,019; 9,049,967 and 9,107,539.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A food processor having a jar body assembly and a base with a motor drive located within the base, the jar body assembly comprising:
a first shaft or rod having a blade assembly disposed on a proximal end, the first shaft having a second shaft disposed therein and adapted to move within the first shaft and protruding from a distal end of the first shaft, the first shaft having a top blade member disposed on an upper distal end spaced above the blade assembly;
a spur gear assembly coupled to the first shaft for axially rotating the first shaft at the proximal end, the spur gear assembly including a first spur gear coupled to the first shaft and a second spur gear coupled laterally to the first spur gear; and
a worm gear assembly coupled to the spur gear assembly and to the first shaft, a drive shaft of a worm gear of the worm gear assembly coupled to the second spur gear and a worm wheel gear of the worm gear assembly coupled to a base member of the proximal end of the second shaft to translationally move the second shaft vertically in an oscillating motion, the drive shaft of the worm gear configured to be coupled to and driven by the motor drive in the base.

2. The food processor of claim 1, wherein the spur gear assembly is comprised of two helical gears having a 1:1 ratio.

3. The food processor of claim 1 wherein a hypoid gear assembly is coupled to the first shaft for axially rotating the first shaft.

4. The food processor of claim 1, wherein the blade assembly is selected from the group consisting of a single blade, a dual blade assembly and a triple blade assembly.

5. The food processor of claim 1, wherein the top blade member is selected from the group consisting of a single blade, a dual blade assembly and a triple blade assembly.

6. A food processor having a jar body assembly and a base with a motor drive located within the base, the jar body assembly comprising:
a shaft having a blade assembly disposed on a distal end of the shaft and a base member disposed on a proximal end of the shaft;
a spur gear assembly coupled to the shaft for axially rotating the shaft, the spur gear assembly including a first gear coupled to the shaft and a second gear coupled laterally to the first gear; and
a worm gear assembly coupled to the spur gear assembly and to the shaft, a drive shaft of a worm gear of the worm gear assembly coupled to the second gear and a worm wheel gear of the worm gear assembly coupled to the base member of the proximal end of the shaft to translationally move the shaft vertically in an oscillating motion, the drive shaft configured to be coupled to and driven by the motor drive in the base.

7. The food processor of claim 6, wherein the spur gear assembly is comprised of two helical gears having a 1:1 ratio.

8. The food processor of claim 6, wherein the blade assembly is selected from the group consisting of a single blade, a dual blade assembly and a triple blade assembly.

9. The food processor of claim 6, wherein the top blade member is selected from the group consisting of a single blade, a dual blade assembly and a triple blade assembly.

10. The food processor of claim 3, wherein the blade assembly is selected from the group consisting of a single blade, a dual blade assembly and a triple blade assembly.

11. The food processor of claim 3, wherein the top blade member is selected from the group consisting of a single blade, a dual blade assembly and a triple blade assembly.

12. A food processor jar body assembly forming part of a food processor system, the food processor system having the jar body assembly and a base with a motor drive located within the base, the jar body assembly comprising:
a shaft body and a blade assembly disposed within an upper portion of the jar body assembly, the jar body assembly having a lower portion and a floor separating the upper and lower portions of the jar body assembly, the shaft body having an inner shaft disposed therein with the blade assembly disposed on a distal end of the inner shaft, the inner shaft having a base member disposed on a proximal end of the inner shaft, the base member configured to be engaged with the motor drive and axially rotate the inner shaft independent of the shaft body; and
a worm gear assembly disposed within the lower portion of the jar body assembly and below the floor, the worm gear assembly operatively coupled to the shaft body and configured to translationally move the shaft body vertically in an oscillating motion, the worm gear assembly including a threaded bracket member disposed about the shaft body and at least one worm gear shaft engaged with the threaded bracket member, the at least one worm gear shaft having a worm gear shaft base member disposed on a proximal end of the worm gear shaft, the worm gear shaft base member configured to be engaged with a second motor drive to translationally move the threaded bracket member and the shaft body vertically in an oscillating motion.

13. The food processor jar body assembly of claim 12, wherein the worm gear assembly includes a second and a third worm gear shaft engaged with the threaded bracket member, and wherein the jar body assembly further includes an idler gear assembly disposed within the lower portion of the jar body assembly and configured to engage the first, second and third worm gear shafts in imparting a rotational movement to the worm gear shafts when the first worm gear shaft is engaged with the second motor drive.

14. The food processor jar body assembly of claim 13, wherein the idler gear assembly includes at least a first idler gear disposed about the first worm gear shaft, a second idler gear disposed about to the second worm gear shaft and a third idler gear disposed about the third worm gear shaft.

15. The food processor jar body assembly of claim 14, wherein the idler gear assembly includes a fourth and a fifth idler gear and all of the idler gears are in operative contact with each other in imparting the rotational movement to the worm gear assembly.

16. The food processor jar body assembly of claim 13, further comprising a worm gear assembly support plate configured to support the threaded bracket member and to support the first, second and third worm gear shafts radially about the threaded bracket member.

17. The food processor jar body assembly of claim 12, further comprising at least two electrical limit switches electrically coupled to the second motor and configured to change the direction of translational travel of the shaft body.

18. A food processor jar body assembly of claim 12 wherein the inner shaft base member and the worm gear assembly base or coupling member are configured in a ring with external fins disposed radially about the ring structure to facilitate engaging the motor drives.

19. A food processor jar body assembly of claim 12 further comprising a stabilizer bracket disposed about the shaft body and below the blade assembly to engage the floor of the jar body assembly and seal the upper portion of the jar body assembly from the lower portion.

20. A food processor jar body assembly of claim 12 wherein the blade assembly is selected from the group consisting of a single blade, a dual blade assembly and a triple blade assembly.
